(19) United States
(12) Patent Application Publication
(10) Pub. No.: US 2009/0321415 A1
(43) Pub. Date: Dec. 31, 2009

(54) FLEXIBLE HEATER COMPRISING A TEMPERATURE SENSOR AT LEAST PARTIALLY EMBEDDED WITHIN

(75) Inventors: Wenwei Zhang, Scotland (GB); Vipin Pillai, Bellshill (IN)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: Honeywell International Inc.

(21) Appl. No.: 12/145,689

(22) Filed: Jun. 25, 2008

(51) Int. Cl. H05B 3/34; H05B 3/36; H05B 1/02

(52) U.S. Cl. 219/528; 219/544; 219/494

(57) ABSTRACT

A flexible heater 200 includes at least one hot wire resistive element 215 and a thermally insulating and electrically insulating flex holding material (201, 202) surrounding the resistive element (215) for holding the resistive element (215). A temperature sensor (225) having at least a portion embedded in the holding material is operable for measuring a temperature of at least one location along a length of the resistive element (215). A monitored flexible heater system (600) includes a flexible heater (610) including at least one resistive element, a thermally insulating and electrically insulating flex holding material surrounding the resistive element and a temperature sensor (615) having at least a portion embedded in the holding material operable for measuring a temperature of at least one location along a length of the resistive element. The system (600) includes a temperature measurement system (620) coupled to the temperature sensor (615) for measuring a temperate at the location, a processor (625) coupled to the temperature measurement system to receive data including the temperature, and a circuit breaking switch (630) positioned in a power path that delivers power to the flex heater, wherein the processor (625) is operable to provide control signals to control a state of the switch, wherein the control signals are operable to open the switch (630) when the temperature exceeds a predetermined temperature.

### FIELD

The present invention generally relates to flexible heaters, and in particular, to flexible heaters having temperature sensors.

### BACKGROUND

Flexible (or “flex”) heaters are essentially resistive elements, which are sandwiched into variety of the flexible polymeric holding materials such as KAPTON®, a polyamide or silicone rubber to form flex heaters. Units can be designed into three-dimensional shapes and conformed to a variety of complex geometries.

The resistive elements are often referred to as hot wires as they are generally in wire form and become heated when a potential difference from a power supply is applied across the elements. FIG. 1A shows the pattern for a conventional resistive element 100 for a flex heater. Conventionally, the resistive element pattern is formed by chemically etching a metal foil. The metal foil is generally around 0.018 inches thick. Micromachining may also be used. As known in the art, the hot spot or heated zone can be varied by the geometry of the resistive element pattern.

The generally polymeric holding materials basically provide the functions of electrical isolation and flex holding, making sure the flex heater is electrically isolated from the heated targets and flexibly suited to the shape of the heated targets. FIG. 1B shows a flex heater 150 having a conventional laminated sandwich structure. Heater includes a generally rubber comprising base layer 110 which forms the bottom of the sandwich and top layer 120 which forms the top of the sandwich. The resistive element 115, commonly referred to as heater wire, is interposed between base layer 110 and top layer 120. A cover layer 130 is shown on top of top layer 120.

As known in the art and shown in FIG. 113, layers 110, 120, and 130 generally each comprise three (3) sub layers. The top and bottom sub layers are made of a highly flexible material, such as a silicone rubber. To enhance the wearability the flex heater 150, the middle sub layer elements generally comprise more dense layers which are typically textured, which make the layers 110, 120 and 130 and thus the flex heater flex 150 resistant to puncture. Layers 110, 120, and 130 are available commercially, such as Arlon product number 51576R015, which comprises silicone rubber top and bottom sub layers and 7628 style fiberglass in the middle sub layer (Arlon Silicone Technologies Division, Bear, Del. 19701).

A pan layer 140 which provides heat spreading generally comprising aluminum is adhered to cover layer 130 using a conventional curing process. In operation, a heater target 145 is placed on the pan 140 for heating by flex heater 150.

Flex heater 150 is generally formed by curing the respective layers under a heated press under pressure using a vulcanized process. While curing, the sandwich 110/115/120 is cured on to a pan or any substrate to heat. Post curing is generally performed in an aerated oven.

Flex heater products are currently used for a large variety of markets, applications and customers. The markets served include, but are not limited to, medical, commercial, automotive and aerospace.

During the design and manufacturing of flex heaters, there are generally known tradeoffs among the resistive values, resistive pattern, heat-up efficiency, and reliability of the flex system. Before the heated target is warmed up, a generally worst case event can occur where the flex heater can be burned up, causing damage to the flex heater, and thus causing the danger to the end user. The holding materials in the flex heater may also outgas before the temperature is balanced at the heated target, causing problem for the end user.

Due to the thermal insulating properties of conventional flex holding materials, non-contact thermal sensors are not able to monitor the temperature of the hot wire. Also, because of the large size, large thermal mass, electrical conduction, and coefficient of thermal expansion (CTE) mismatching and slow response, conventional solutions including thermistors do not generally meet the need for temperature accuracy, response speed or even assembly ease in the flex heater system. Although simulation tools such as computational fluid dynamics (CFD) analysis are available to predict outgassing and burning situations for holding materials, the simulation tools can generate significantly inaccurate results due to complex boundary conditions, which render CFD of little help for guiding the design and manufacturing of the flex heater to provide a desired safety margin. Therefore, an accurate and reliable real time temperature sensor that is small in size and thermal mass so as to minimize the change in thermal profile of the flex heater is needed.

### SUMMARY

This Summary is provided to comply with 37 C.F.R. §1.73, requiring a summary of the invention briefly indicating the nature and substance of the invention. It is submitted with the understanding that it will not be used to interpret or limit the scope or meaning of the claims.

Embodiments of the invention provide a flexible heater comprising at least one resistive element (generally referred to as a “hot wire”), a thermally and electrically insulating flex holding material surrounding the resistive element for holding the resistive element, and a temperature sensor having at least a portion embedded in the holding material. The temperature sensor is operable for measuring a temperature of at least one location along a length of the resistive element. The location measured is generally what is referred to as the “hot spot”, which corresponds to the specific location on the resistive heater that heats to the highest relative temperature during operation of the flex heater. As described above, as known in the art, the location of the hot spot can be varied by varying the geometry of the resistive element.

As defined herein, the term “flexible heater” refers to a resistive element built into a flexible holding material, such as a silicone rubber, a polyimide (e.g. KAPTON®), a polyamide (e.g. NYLON®), mica, polytetrafluoroethylene, NYLON®, a polyester (e.g. biaxially-oriented polyethylene terephthalate (boPET) polyesters, such as MYLAR®) to form a heater system. MYLAR® can be a holding substrate to provide an optically transparent flexible heater. Thus as a whole, the heater system can generally form in any shape in three (3) dimension and be adhered onto the surface of a heated target independent of the shape and structure of the heated target. As a result, a flexible heater can conform to the surface which requires heating. There are many varieties of flexible heaters which can include silicone rubber heaters, KAPTON® heaters, heating tapes, heating tapes with thermostats, rope heaters, and wrap around tank heaters, gas cylinder heaters and custom sizes. Silicone Flexible Heaters are lugged, reliable, accurate, and moisture and chemical-resistant.

In a typical embodiment, the temperature sensor is embedded near the hot spot of the hot wire. In one embodiment the sensor is optical fiber-based and having its tip embedded therein in another embodiment the sensor is resistance temperature detection (RTD)-based. Temperature sensors according to embodiments of the invention generally are small in size and thermal mass so that they minimize the change in thermal profile of the flex heater during testing or monitoring.

In one embodiment, an optical Bragg grating fiber with a mechanical enhancing outer sleeve is used to measure wire temperature of the flex heater. An enhanced matching material sleeve is generally selected to protect optical fiber from mechanically damage, provide good thermal conductivity to improve the response of the optical fiber sensor, provide a small mass to avoid changing the thermal profile of the flex heater, and provide coefficient of thermal expansion (CTE) matching during exposure of high temperature.

In a second embodiment, a piece of wire that has a electrical resistance that is temperature sensitive, referred to generally as temperature sensitive wire, is applied as a wire temperature coupler which is aligned as close as possible to the hot spot of the resistive element of flex heater (but not in electrical contact). The temperature sensitive wire can comprise platinum, nickel or other metal or composite materials. The wire temperature coupler can be inserted prior to assembly of the flex holding material with the resistance element and the wire temperature coupler. This embodiment generally provides a wide temperature sensing range, good linearity, and a small mass to avoid changing the thermal profile of the flex heater due to small thermal mass of the sensing metal wire.

### BRIEF DESCRIPTION OF THE DRAWINGS

FIG. 1A shows a pattern for an exemplary conventional resistive element for a flex heater.

FIG. 1B shows a flex heater having a conventional laminated sandwich structure.

FIG. 2 shows a depiction of flex heater according to an embodiment of the invention having a fiber optic temperature sensor having its tip embedded therein.

FIG. 3 is a depiction of an exemplary sleeved fiber optic probe, according to an embodiment of the invention.

FIG. 4 is a block diagram of a fiber-optic based temperature measurement system coupled to a fiber optic probe embedded inside a flex heater, according to an embodiment of the invention.

FIG. 5 shows a sectional virtual cut-away depiction of a portion of flex heater according to an embodiment of the invention having a metal resistance thermometer comprising a metal element having a composition different from a composition of the hot wire element.

FIG. 6 is a block diagram of a monitored flexible heater system according to an embodiment of the invention comprising a flexible heater, a temperature measurement system including a temperature sensor according to an embodiment of the invention, a processor, and a circuit breaking switch.

FIG. 7 shows an exemplary testing arrangement for determining the hot wire temperature near the hot spot with a Bragg grating optical fiber sensor solution according to an embodiment of the invention.

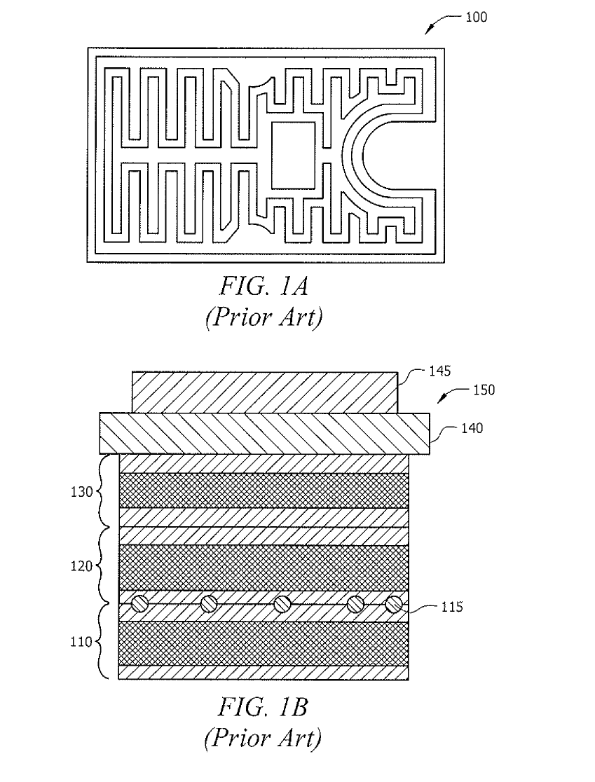

### DETAILED DESCRIPTION

The present invention is described with reference to the attached figures, wherein like reference numerals are used throughout the figures to designate similar or equivalent elements. The figures are not drawn to scale and they are provided merely to illustrate the instant invention. Several aspects of the invention are described below with reference to example applications for illustration. It should be understood that numerous specific details, relationships, and methods are set forth to provide a full understanding of the invention. One having ordinary skill in the relevant art, however, will readily recognize that the invention can be practiced without one or more of the specific details or with other methods. In other instances, well-known structures or operations are not shown in detail to avoid obscuring the invention. The present invention is not limited by the illustrated ordering of acts or events, as some acts may occur in different orders and/or concurrently with other acts or events. Furthermore, not all illustrated acts or events are required to implement a methodology in accordance with the present invention.

The invention will now be described more fully hereinafter with reference to accompanying drawings, in which illustrative embodiments of the invention are shown. This invention, may however, be embodied in many different forms and should not be construed as limited to the embodiments set forth herein.

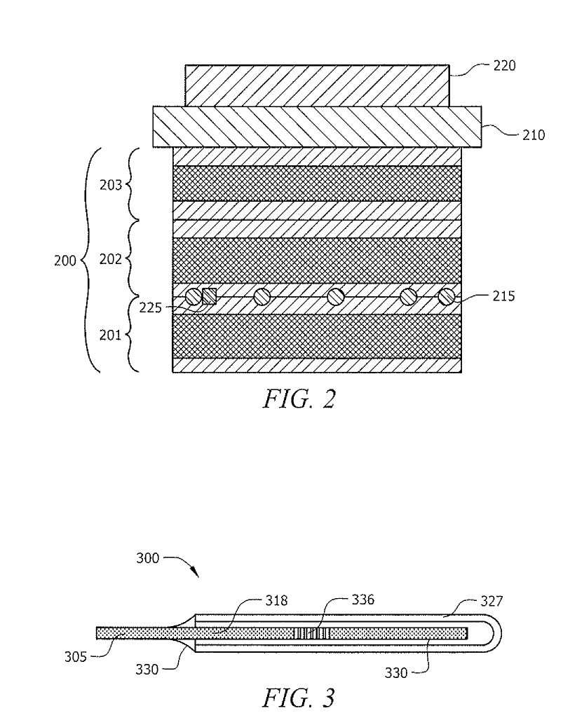

FIG. 2 shows a depiction of flex heater 200 according to an embodiment of the invention having an embedded fiber tip 225 of a fiber optic temperature sensor (not shown in FIG. 2; instead see FIG. 3) adhered onto a pan 210 to heat up a heating target 220. Flex heater 200 has a conventional laminated sandwich structure. Heater 200 generally includes a rubber comprising base layer 201 which forms the bottom of the sandwich. Top layer 202 forms the top of the sandwich. The heater wire 215 is interposed between base layer 210 and top layer 202. A cover layer 203 is shown on top layer 202.

As described above, temperature sensing embodiments of the invention generally are both small in size and thermal mass so that they minimize the change in thermal profile they introduce to the flex heater during testing or monitoring. The diameter of fiber tip is generally on the order of 100 to 160 μm, such as 125 μm and can have a length of several mm, such as about 10 mm. A small thermal mass temperature sensor is provided by embodiments of the invention providing a material having features of small volume and relatively high thermal conductivity. Thus, a material with a small thermal mass will not measurably hold the temperature tested, resulting in a quick response time, and not significantly change the thermal profile of the heating source, thus resulting in an accurate measurement of the tested temperature. For example, in a typical embodiment the specific heat parameter for a silica optical fiber is generally about 740 J/Kg·K. The density of the optical fiber tip is typically around 2.23 g/cm³. Assuming the diameter of optical fiber is around 125 μm and the length of the fiber optic temperature sensor is around 10 mm, then volume is 1.22×10⁻⁴ cm³. Thus the mass of the sensor is around 0.27 mg. In this case, 0.2 mw of power is absorbed to increase the temperature of optical fiber by 1° C./s (=1 K/s). Considering a 150 W heating power of a flex heater, even for a 200K per second temperature rise, the fiber optic temperature sensor will only absorb about 0.04 W of power, which is negligible to overall power of heater. Thus, the fiber optic temperature sensor will not measurably affect the profile of heating distribution.

In addition, the thermal conductivity of the optical fiber, which can be defined as a flux of heat (energy per unit area per unit time) divided by a temperature gradient (temperature difference per unit length), for a typical silica fiber described above is 1.38 W/m·K. Combined with the thermal conductivity 0.15 W/m·K of the substrate silicone, the optical fiber has better thermal conductivity as compared to the silicone substrate/holding material. Thus the fiber will sense temperature promptly before the substrate/holding material dissipates the heat on the heated target.

FIG. 3 is a view of an exemplary sleeved fiber optic probe 300, according to an embodiment of the invention. The optical fiber 318 is encased in an outer protective sleeve 327. The region between the fiber 318 and outer sleeve 327 is shown filled with a high temperature adhesive/cement 330. The optical fiber 318, typically comprises silica, but can be other suitable materials such as borosilicate, sapphire. Fiber optic probe 300 is generally able to sense temperatures up to at least 400° C.

Formed within optical fiber 318 is a wavelength-selective reflector 336, shown as an integrally formed fiber Bragg grating. More generally, the wavelength selective reflector 336 need not be integrally formed in the fiber 318 (e.g. glued onto the end of an optical fiber).

As known in the art of optics, a fiber Bragg grating is an optical fiber device that includes an optical fiber with periodic changes in the refractive index of fiber core materials along the fiber length, which may be formed by exposure of the photosensitive core to an intense optical interference pattern. With the changes in the refractive index along the fiber length, optical beams at a particular wavelength are reflected by the fiber Bragg grating while other wavelengths are allowed to propagate through the fiber 318. It is also known that the reflection wavelength X of the grating 336 changes with temperature (Δλ/ΔT) due to the change in refractive index and grating spacing over temperature.

An integral fiber Bragg grating 336 can be written directly on the optical fiber 318 as described by the exemplary method provided below. A photosensitive fiber with Germanium doped in the core can be placed in an optical field. A UV wavelength emitting laser is focused along the axial direction of optical fiber but stretched along the cross section direction of the fiber. The optical beam is steered and shined on the fiber surface through a phase mask (PM). The phase mask will modulate the light intensity incident on the optical fiber and the steering mirror will steer the light on the different position along the fiber surface. This process forms a periodic piece of Bragg grating on the optical fiber, which forms the temperature sensing element. The optical fiber tip 305 includes an outer protective sleeve 327 which provides a mechanical enhancement to protect the Bragg grating shown in FIG. 3 when it is exposed at stress during flex system assembly and application. This leaves the Bragg grating 336 essentially only exposed to the temperature tested. The material for sleeve 327 should have properties of mechanical strength, high thermal conductivity to be able to transfer the tested temperature to the grating 336 with little delay, have a small thermal mass, which is generally provided given the small physical mass and better thermal conductivity as compared to the optical fiber tip, avoiding a significant change to the thermal profile during testing, CTE matching with optical fiber 318, and electrically isolation. Electrical isolation for sleeve 327 is helpful for avoiding any potential shore circuit which can cause danger during applications, such as when aligning the optical fiber along the resistive element.

A glass ceramic material such as ZERODUR™ developed by Schott Glass Technologies is one material that generally provides the desired properties described above. ZERODUR™ is a glass ceramic with an extremely low thermal expansion coefficient (0.02×10⁻⁶/K at 0 to 50° C). ZERODUR™ belongs to the glass-ceramic composite class of materials and has both an amorphous (vitreous) component and a crystalline component. ZERODUR™ has good properties of mechanical strength, a thermal conductivity of about 50 W/m·K, and close matching (˜0.02×10⁻⁶/K at 0 to 50° C.) CTE (˜0.2×10⁻⁶/K at 0 to 50° C.). Considering a 10 mm long sleeve, the difference of the sleeve and optical fiber due to temperature could be only 0.36 um since the CTE difference of the two materials in this example is 0.18×10⁻⁶/K. Thus, the expansion difference in 200° C. and 10 mm length is 0.18×10⁻⁶/K×200×10 mm=0.36 μm). This 0.36 μm difference between optical fiber 318 and sleeve 327 will not cause any significant stress on Bragg grating, thus minimizing the test error. In contrast, significant stresses between the fiber 318 and the sleeve 327 can cause a significant change in the refraction index of grating layers in the Bragg grating 336, which can cause a significant test error for the measured temperature.

High temperature adhesive/cement 330 can comprise a high-temperature glass frit or Aremco Products Inc.'s ARMC-685N glue (Aremco Products, Valley Cottage N.Y.) to cure the optical fiber 318 together with the sleeve 327. As an example, ARMC-685N glue can work up to about 1371° C. Adhesive/cement 330 should generally at least decent thermal conductivity (e.g. at least about 20 W/m·K.

Since the Bragg grating 336 can generally be 125 μm or less in diameter, the sleeve 327 in the case of a 125 μm diameter Bragg grating 336 can be about 250 μm outer diameter and about 150 μm internal diameter to provide good mechanical support for the optical fiber 318 inside. This small size possible for sleeve 327 minimizes the thermal mass of the sleeve and thus induced changes in the thermal profile of the tested hot wire 215. Adhesive/cement 330 generally also has a small thermal mass being on the order of 25 μm thick. The low thermal mass of and good thermal conductivity of the sleeve 327 and adhesive/cement 330 allows the heater temperature to generally be detected in millisecond response speed by fiber optic probe 300.

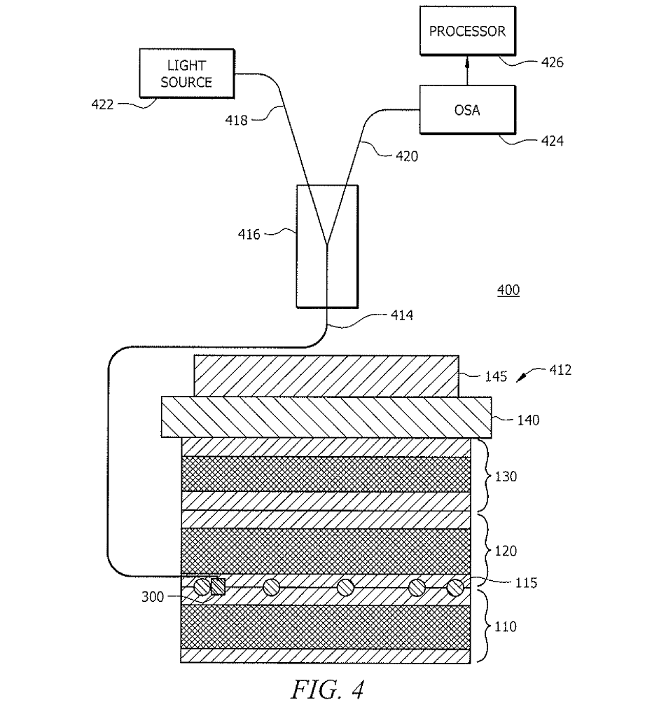

FIG. 4 is a block diagram of a fiber-optic based temperature measurement system 400 coupled to a fiber optic probe 300 having its tip 305 (shown in FIG. 3) embedded inside a flex heater 412, according to an embodiment of the invention. Extending from the probe 300 is an optical fiber 414. An optical coupler 416 joins the probe fiber 414 to two additional fibers 418 and 420. The fiber 418 carries light (typically uv, visible or infrared) from a broadband light source 422 to the probe 300 via the coupler 416, and the fiber 420 carries reflected light from the probe 300 to an optical spectrum analyzer (OSA) 424, which comprises a photodetector such as a charge-coupled device (CCD) array. The electrical outputs of the OSA 424 generally after filtering and amplification A/D conversion are coupled to a processor 426, which is operable to calculate the temperature at the position of Bragg grating or other temperature sensing element. Furthermore, the respective system components shown in separate blocks (416, 418, 420, 422, 424, 426) in FIG. 4, can all be integrated into a single instrument, thus forming dedicated interrogation equipment.

The broadband light source 422 can be implemented by a LED or other suitable broadband source. The range of optical wavelengths from the source 422 encompasses a range of reflectance frequencies of a fiber Bragg grating employed within the probe 300.

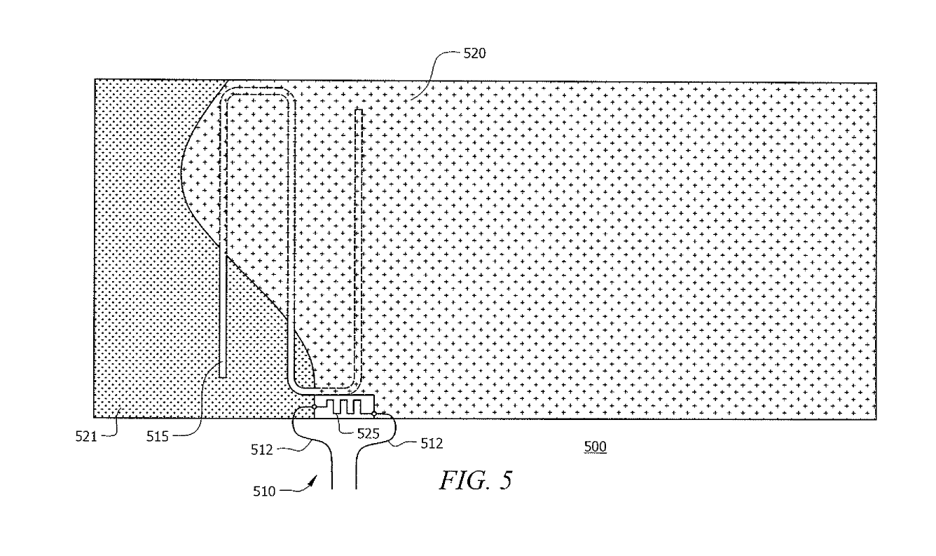

FIG. 5 shows a sectional virtual cut-away depiction of a portion of flex heater 500 including flex holding material layers 520 and 521 having a hot wire resistive element 515 therein, according to an embodiment of the invention. Flex heater 500 includes a metal resistance thermometer 510 comprising a metal or metal alloy wire 525 (referred to as a “coupler wire”) having a composition different from a composition of the hot wire 515. Hot wire 515 is sandwiched between layers 520 and 521 the holding material. Layer 520 can be the substrate, and layer 521 the cover on the hot wire 515, since the resistive value of the metal or metal alloy coupler wire 525 is sensitive to the tested temperature in the hot wire 515, the temperature can be detected at the hot spot of the hot wire 515 by measuring the resistive value through the two leads 512 associated with the metal or metal alloy coupler wire 525. Coupler wire 525 is embedded in the flex heater in proximity (e.g. around 0.3 to 0.8 mm, such as about 0.5 mm, far enough away to avoid creating a short circuit with the hot wire 515, but close enough to keep the response time as short as possible and to accurately reflect the temperature of the hot wire 515.

Metal resistance thermometer 510 is generally placed near the hot spot within sandwich structure. As described above, for a small thermal mass of coupler wire 525, the temperature sensor 510 will not significantly change the thermal profile of the tested heater wire 515. In terms of small thermal mass of coupler wire 525, a particular example is provided below. The specific heat of platinum is 130 J/Kg. K. The density of the platinum is 21.45 g/cm³. Assuming the diameter of the platinum wire to be around 0.2 mm and the length of the sensing parts to be around 20 mm, the volume is 6.28×10⁻⁴ cm³. Thus the mass is around 13.5 mg. Accordingly, 1.75 mw is absorbed to increase the temperature of platinum wire by 1 K/s. Considering that the 150 W heating power of a flex heater, even 200 K per second temperature rising only absorbs 0.35 W, which is negligible to overall power of heater. Thus it will not measurably affect the profile of heating distribution. In addition, the thermal conductivity of platinum is about 73 W/m·K. As combined with the thermal conductivity 0.15 W/m·K of a silicone substrate, the platinum wire 525 has better thermal conductivity. Thus, the platinum wire will sense temperature promptly before the substrate dissipates the heat onto the heated target. Thus the mass of the coupler wire is sufficiently small to not measurably change the temperature distribution of the hot wire. Also the wire will response the temperature quickly for example responding 200° C. rising within 1 second. Moreover, since wire for coupler wire 525 is generally a flexible wire, the metal resistance thermometer 510 can generally be bent to any shape to measure the temperature of hot wire 515 as long as the coupler wire 525 is positioned proximate to hot wire 515.

The metal resistance thermometer 510 operation can be based on the electrical resistance properties of a variety of metals (e.g. copper, silver, aluminum, platinum) which increases approximately linearly with absolute temperature. This feature makes them useful as temperature sensors. In practice, considering the features of high temperature stability, linearity, and flexibility, platinum wire is generally used for coupling of temperature at the hot spot. As known in the art, the resistance of a wire of the metal material is measured by passing a current (AC or DC) through it and measuring the voltage with a suitable bridge or voltmeter, and the reading is converted to temperature using a calibration equation.

Platinum is often used in metal resistance thermometer applications due to its relatively high temperature coefficient and thoroughly characterized R vs. r characteristics. The length and diameter of the platinum wire used in such thermometers are often chosen so that the resistance of the device at around 0° C. is 100 ohms. Such a sensor is a called a PT100 sensor, and its resistance changes by approximately 0.4 ohms per degree Celsius. Using a typical 1 mA measuring current, at around 0° C. a PT100 sensor would have a voltage drop of around 100 mV across its terminals and this would change by approximately 0.4 mV per degree Celsius, which thus makes sensitive thermometry available with a high resolution voltmeter or resistance bridge. In many instruments the measurement is converted so that the reading is directly in temperature.

Since the coupler wire 525 of metal resistance thermometer 510 is thin (generally around 0.2 mm in diameter), there is only a minimal change of the thermal profile at the hot spot or other located of heater wire that is tested. Thus, metal resistance thermometer 510 can provide real time measurements for the temperature for the heater wire at one or more desired locations.

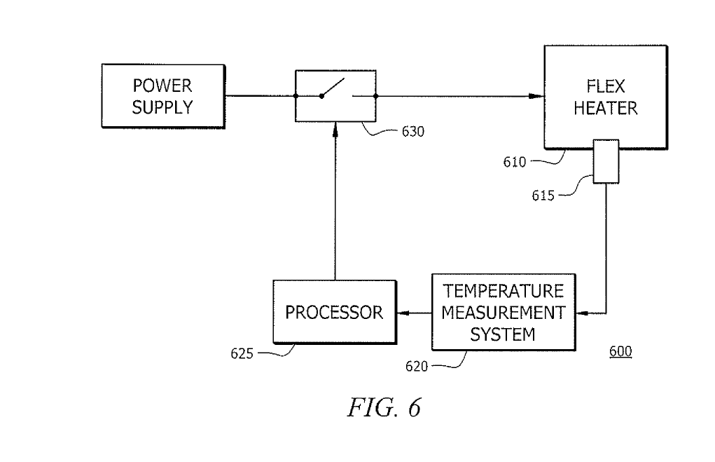

FIG. 6 is a block diagram of a monitored flexible heater system 600 according to an embodiment of the invention comprising a flexible heater 610, embedded temperature sensor 615, a temperature measurement system 620, a processor 625, and a circuit breaking switch 630. Although wire interconnections are show, connections between components of system 600 can be at least in part over the air with suitable antennas, transmitters and receivers added, or in another embodiment optically communicated. With interrogation equipment is in place, the temperature profile of the fiber tip can be tested in real time. In the case of the wireless embodiment, a single a temperature measurement system 620 and processor 625 can simultaneously monitor a plurality of flexible heaters 610 having embedded temperature sensors according to embodiments of the invention.

There are a variety of laboratory uses for embodiments of the invention, as well as end user/consumer uses. An exemplary laboratory use, it is often needed for the temperature of the hot spot of the flex heater to be characterized in real time during the design and manufacturing stage, without measurably changing the thermal profile of the flex heater. At the design stage, the hot wire temperature tests can be used to guide the design of the flex heater, indicating whether the design is robust enough or not robust enough considering of all the tolerances of heating resistive elements, flex holding material, thermostat, and the heated load. Another application is post assembly, where it is an important component in the testing solution for the products, making data available for the user/customer to know the temperature of the wire during the various stages of applications, helping to avoid potential risks.

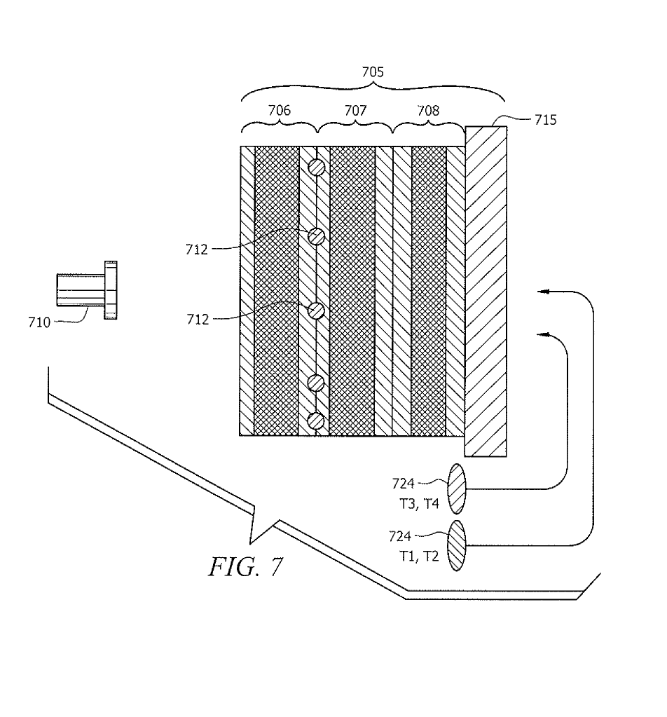

A testing arrangement 700 and related procedure according to embodiments of the invention for determining the position of the hot spot in the flex heater is shown in FIG. 7. Arrangement 700 is useful during the design stage of a flex heater. The purpose of testing arrangement 700 and the related procedure is to find a location very close to the exact position of the hot spot at the flex heater using non contact methods according to embodiments of the invention. This method will not generally provide the actual temperature on the hot wire. After identification of the position of the hot spot, the optical fiber tip of temperature sensor 300 or metal resistance thermometer 510 (temperature coupler) can be integrated at that position during assembly/production. First, a thermal camera 710 can be used to locate the hot spot 718 on the flex heater 705 by recording the temperature distribution using the arrangement shown in FIG. 7 during operation of the flex heater, before embedding a temperature sensing probe according to an embodiment of the invention. Flex heater 705 includes a hot wire 712 sandwiched between a generally rubber base layer 706 which forms the bottom of the sandwich and top layer 707. Cover layer 708 is on top of layer 707, and pan 715 is on cover layer 708. Pan 715 is generally rectangularly shaped. Thermistors 724 are external to the flex heater 705, and are shown mounted on a heating target, such disposed on pan 715 (not shown). The function thermistors 724 is to monitor the temperature of the pan or heating target on the pan closely, making sure the overall temperature range is within specification. The reason several thermistors are generally applied is that the temperatures at the several positions of the heating target all generally need to be within the product specification for flex heater 705. However, because thermistors 724 are external to the flex heater 705 (e.g. on the pan 715), the thermistors do not sense the temperature of the hot wire 712 in the flex heater 705. Thermistors 724 making sure the overall temperature of the heating target will be within the specification for the flex heater 705.

In this example there are 4 thermistors 724 comprising T1, T2, T3 and T4 which are located at the four corners of the pan 715. T1 and T2 can be located at a first diagonal direction of the pan 715, and T3 and T4 can be located at other diagonal direction of pan 715. Such an arrangement of thermistors 724 helps make sure the overall temperature across the full area of the heating target will be within the specification for the flex heater 705.

As known in the art, thermographic cameras detect radiation in the infrared range of the electromagnetic spectrum (roughly 900-14,000 nm or 0.9-14 μm) and produce images of that radiation, which can be used to identify the hot spot. Then, a temperature sensing probe according to an embodiment of the invention, such as the optical fiber tip of a sleeved fiber optic probe, can be embedded at the hot spot 718 before completing assembly of heat flex. Then the layers 706-708 are assembled to the pan 715 using a curing process. Finally, when the power is turned on, the fiber tip of the sensor inserted at the hot spot 718 starts to sense the temperature at the hot spot in a real time. Thus the hot spot temperature will be detected. The collected data at the hot spot can be used to guide the design and manufacture of the flex heater 705.

Thus, embodiments of the invention can be used to guide the design of the heater (e.g. hot wire geometry), target the location for embedding the sensor to be proximate to the hot spot. Moreover, embodiments of the invention can be used to correct/update a simulation database for flex heaters. In other embodiments, embodiments of the invention can be used to provide operating instructions and/or warnings to end users, including embodiments which implement an automatic circuit breaking function when a maximum predetermined temperature is detected, such as described above relative to FIG. 6.

While various embodiments of the present invention have been described above, it should be understood that they have been presented by way of example only, and not limitation. Numerous changes to the disclosed embodiments can be made in accordance with the disclosure herein without departing from the spirit or scope of the invention. Thus, the breadth and scope of the present invention should not be limited by any of the above described embodiments. Rather, the scope of the invention should be defined in accordance with the following claims and their equivalents.

Although the invention has been illustrated and described with respect to one or more implementations, equivalent alterations and modifications will occur to others skilled in the art upon the reading and understanding of this specification and the annexed drawings. In particular regard to the various functions performed by the above described components (assemblies, devices, circuits, systems, etc.), the terms (including a reference to a “means”) used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the invention. In addition, while a particular feature of the invention may have been disclosed with respect to only one of several implementations, such feature may be combined with one or more other features of the other implementations as may be desired and advantageous for any given or particular application. Furthermore, to the extent that the terms “including”, “includes”, “having”, “has”, “with”, or variants thereof are used in either the detailed description and/or the claims, such terms are intended to be inclusive in a manner similar to the term “comprising.”

We claim:

1. A flexible heater, comprising:
at least one resistive element;
a thermally insulating and electrically insulating flex holding material surrounding said resistive element for holding said resistive element, and
a temperature sensor having at least a portion embedded in said holding material operable for measuring a temperature of at least one location along a length of said resistive element.

2. The heater of claim 1, wherein said heater is a laminate article, said resistive element being sandwiched between top and bottom layers of said flex holding material.

3. The heater of claim 1, wherein said temperature sensor comprises a fiber optic temperature sensor comprising at least one optical fiber and a wavelength selective reflector coupled to said optical fiber.

4. The heater of claim 3, wherein said wavelength selective reflector comprises at least one Bragg grating.

5. The heater of claim 4, wherein said Bragg grating is integrated with said optical fiber.

6. The heater of claim 3, further comprising a sleeve surrounding said fiber.

7. The heater of claim 6, wherein said fiber comprises optical glass and said sleeve has a bulk thermal conductivity of at least 1.3 W/m·K, and a coefficient of thermal expansion expansion (CTE) within 20% of a CTE of said optical glass.

8. The heater of claim 7, wherein said sleeve comprises a glass ceramic material.

9. The heater of claim 1, wherein said temperature sensor comprises an electrical resistance-based thermometer comprising a sensing element having a composition different from a composition of said resistive element.

10. The heater of claim 1, wherein said flex holding material comprises a silicone rubber, a polyimide, a polyamide, mica, polytetrafluoroethylene, or a polyester.

11. A monitored flexible heater system, comprising:
a flexible heater comprising at least one resistive element, a thermally insulating and electrically insulating flex holding material surrounding said resistive element for holding said resistive element, and a temperature sensor having at least a portion embedded in said holding material operable for measuring a temperature of at least one location along a length of said resistive element;
a temperature measurement system coupled to said temperature sensor for measuring a temperate at said location,
a processor coupled to said temperature measurement system to receive data including said temperature, and
a circuit breaking switch positioned in a power path that delivers power to said flex heater, wherein said processor is operable to provide control signals to control a state of said switch, wherein said control signals are operable to open said switch when said temperature exceeds a predetermined temperature.

12. The system of claim 11, wherein said temperature sensor comprises a fiber optic temperature sensor comprising at least one optical fiber and a wavelength selective reflector coupled to said optical fiber.

13. The system of claim 12, wherein said wavelength selective reflector comprises at least one Bragg grating.

14. The system of claim 13, wherein said Bragg grating is integrated with said optical fiber.

15. The system of claim 12, further comprising a sleeve over said fiber, wherein said fiber comprises optical glass and said sleeve has a bulk thermal conductivity of at least 1.3 W/m·K, and a coefficient of thermal expansion expansion (CTE) within 20% of a CTE of said optical glass.

16. The system of claim 11, wherein said temperature sensor comprises an electrical resistance-based thermometer comprising a sensing element having a composition different from a composition of said resistive element.

17. A method of designing a flex heater comprising at least one resistive element, a thermally insulating and electrically insulating flex holding material surrounding said resistive element for holding said resistive element, and a temperature sensor having at least a portion embedded in said holding material operable for measuring a temperature of at least one location along a length of said resistive element having, comprising:
thermally imaging said flex heater before embedding said temperature sensor,
identifying at least one location along said length of said resistive element, and
using said location to embed said temperature sensor in said flex heater proximate to said location.
